(19) United States
(12) Patent Application Publication
(10) Pub. No.: US 2009/0019000 A1
(43) Pub. Date: Jan. 15, 2009

(54) QUERY BASED RULE SETS

(76) Inventors: Mitchell Jon Arends, Rochester, MN (US); Michael Todd Breitbach, Rochester, MN (US); Richard Dean Dettinger, Rochester, MN (US); Frederick Allyn Kulack, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/776,771

(22) Filed: Jul. 12, 2007

(51) Int. Cl. G06F 7/00

(52) U.S. Cl. 707/3

(57) ABSTRACT

Embodiments of the invention provide techniques for processing abstract rule sets in a query engine. In general, the functions and Boolean logic incorporated in an abstract rule are analyzed to determine whether the rule may be processed by a query engine. As a result, the abstract rule as a whole may be processed by a query engine, may be processed in a rule engine, or may be processed in two stages in a query engine and a rule engine.

### CROSS-REFERENCE TO RELATED APPLICATIONS

This application is related to U.S. patent application Ser. No. 11/272,583, Attorney Docket No. ROC920050155US1, entitled “Abstract Rule Sets,” filed Nov. 10, 2005. This related patent application is herein incorporated by reference in its entirety. Further, this application is related to commonly assigned U.S. Pat. No. 6,996,558, issued Feb. 7, 2006, entitled “Application Portability and Extensibility through Database Schema and Query Abstraction,” which is incorporated by reference herein in its entirety. Furthermore, this application is related to commonly assigned, co-pending U.S. patent application Ser. No. 11/005,418, Attorney Docket No. ROC920040198US1, entitled “Abstract Query Plan,” filed Dec. 6, 2004.

### BACKGROUND OF THE INVENTION

1. Field of the Invention

The invention generally relates to computer database systems. More particularly, the invention relates to techniques for processing abstract rule sets.

2. Description of the Related Art

Databases are well known systems for storing, searching, and retrieving information stored in a computer. The most prevalent type of database used today is the relational database, which stores data using a set of tables that may be reorganized and accessed in a number of different ways. Users access information in relational databases using a relational database management system (DBMS).

Each table in a relational database includes a set of one or more columns. Each column typically specifies a name and a data type (e.g., integer, float, string, etc.), and may be used to store a common element of data. For example, in a table storing data about patients treated at a hospital, each patient might be referenced using a patient identification number stored in a “patient ID” column. Reading across the rows of such a table would provide data about a particular patient. Tables that share at least one attribute in common are said to be “related.” Further, tables without a common attribute may be related through other tables that do share common attributes. A path between two tables is often referred to as a “join,” and columns from tables related through a join may be combined to from a new table returned as a set of query results.

Queries of a relational database may specify which columns to retrieve data from, how to join the columns together, and conditions (predicates) that must be satisfied for a particular data item to be included in a query result table. Current relational databases require that queries be composed in complex query languages. Today, the most widely used query language is Structured Query Language (SQL). However, other query languages are also used. A SQL query is composed from one or more clauses set off by a keyword. Well-known SQL keywords include the SELECT, WHERE, FROM, HAVING, ORDER BY, and GROUP BY keywords. Composing a proper SQL query requires that a user understand both the structure and content of the relational database as well as the complex syntax of the SQL query language (or other query language). The complexity of constructing an SQL statement, however, generally makes it difficult for average users to compose queries of a relational database.

Because of this complexity, users often turn to database query applications to assist them in composing queries of a database. One technique for managing the complexity of a relational database, and the SQL query language, is to use database abstraction techniques. Commonly assigned U.S. Pat. No. 6,996,558, entitled “Application Portability and Extensibility through Database Schema and Query Abstraction,” discloses techniques for constructing a database abstraction model over an underlying physical database.

U.S. Pat. No. 6,996,558 discloses embodiments of a database abstraction model constructed from logical fields that map to data stored in the underlying physical database. Each logical field defines an access method that specifies a location (i.e., a table and column) in the underlying database from which to retrieve data. Users compose an abstract query by selecting logical fields and specifying conditions. The operators available for composing conditions in an abstract query generally include the same operators available in SQL (e.g., comparison operators such as =, >, <, >=, and, <=, and logical operators such as AND, OR, and NOT). Data is retrieved from the physical database by generating a resolved query (e.g., an SQL statement) from the abstract query. Because the database abstraction model is tied to neither the syntax nor the semantics of the physical database, additional capabilities may be provided by the database abstraction model without having to modify the underlying database. Thus, the database abstraction model provides a platform for additional enhancements that allow users to compose meaningful queries easily, without having to disturb existing database installations.

Data that is collected and stored in a database can be used as input to analysis routines for various purposes, including know-how management, decision making and statistical analysis. For instance, in a broad variety of applications, analysis routines are executed on query results obtained by executing corresponding queries against an underlying database.

Analysis routines can be defined by rule sets including one or more rules, each having predicates and actions. Commonly, the rules will have the structure “IF [predicate] THEN [action].” A rule predicate is a conditional statement evaluated in a rule engine. If the predicate is satisfied (i.e., the condition is met), then the associated rule action is executed. In other words, a set of rules can be used to implement an analysis routine, and a rule engine can evaluate predicates and fire or execute actions defined in the rules. Where actions of rules are defined to provide recommendations for users, such as treatment recommendations for doctors in medical institutions, the rules can be defined such that corresponding predicates reflect expert-based knowledge of possible diagnoses and evaluations of patient conditions. In other words, rules can be implemented to assist doctors by making diagnosis recommendations, drug recommendations, providing reminders of required verifications and checks, etc.

However, the creation of rules is generally a complex and difficult process which requires detailed knowledge of a corresponding database(s). More specifically, for each predicate and each action of the given rule that the user wants to create, the user requires an understanding of the database schema in order to look up a corresponding column name in the underlying database table(s). One technique for managing the creation of rules is to use abstract rule sets. Commonly assigned U.S. application Ser. No. 11/272,583 (hereafter “the '583 application”), entitled “Abstract Rule Sets,” discloses techniques for using abstract rule sets.

The '583 application discloses that abstract rules must be translated into an executable form that can be processed by the rule engine. Each rule engine includes functions for processing the executable rules. For example, a rule having the predicate “If AVG(level)>40 . . . ” requires that the rule engine include the statistical function “AVG,” or average. However, in some cases, translating an abstract rule into executable form, and processing the rule in the rule engine, can consume a great deal of processing time, and can thus impose a large performance cost. For example, an abstract rule that requires a large number of joins within the abstract data model can produce a large and complicated result set due to the way that the underlying data tables are joined for the translated rule. Such large result sets can cause a rule to be processed slowly.

Therefore, there is a need for improved techniques for processing abstract rule sets.

### SUMMARY OF THE INVENTION

The invention generally relates to computer database systems. More particularly, the invention relates to techniques for processing abstract rule sets.

One embodiment provides a computer-implemented method for processing an abstract rule, comprising: receiving an abstract rule having a conditional statement and a consequential statement; wherein the consequential statement defines a particular recommendation that is returned when the conditional statement is satisfied; wherein the conditional statement and the consequential statement are defined using logical field definitions defined in an abstraction model that models underlying physical data in a manner making a schema of the physical data transparent to a user of the abstraction model; determining one or more functions required to evaluate the conditional statement; determining a logical sequence required for processing the one or more required functions; determining, of one or more required functions, at least one function that can be processed by a query engine; and generating, based on the determined logical sequence, a query statement comprising the determined at least one function, wherein the query statement can be processed by the query engine to evaluate a corresponding portion of the conditional statement.

Another embodiment provides a computer readable storage medium containing a program which, when executed, performs an operation, comprising: receiving an abstract rule having a conditional statement and a consequential statement; wherein the consequential statement defines a particular recommendation that is returned when the conditional statement is satisfied; wherein the conditional statement and the consequential statement are defined using logical field definitions defined in an abstraction model that models underlying physical data in a manner making a schema of the physical data transparent to a user of the abstraction model; determining one or more functions required to evaluate the conditional statement; determining a logical sequence required for processing the one or more required functions; determining, of one or more required functions, at least one function that can be processed by a query engine; and generating, based on the determined logical sequence, a query statement comprising the determined at least one function, wherein the query statement can be processed by the query engine to evaluate a corresponding portion of the conditional statement.

Yet another embodiment provides a system, comprising a processor and a memory containing a program. The program is configured to process an abstract rule by performing an operation, comprising: receiving an abstract rule having a conditional statement and a consequential statement; wherein the consequential statement defines a particular recommendation that is returned when the conditional statement is satisfied; wherein the conditional statement and the consequential statement are defined using logical field definitions defined in an abstraction model that models underlying physical data in a manner making a schema of the physical data transparent to a user of the abstraction model; determining one or more functions required to evaluate the conditional statement; determining a logical sequence required for processing the one or more required functions; determining, of one or more required functions, at least one function that can be processed by a query engine; and generating, based on the determined logical sequence, a query statement comprising the determined at least one function, wherein the query statement can be processed by the query engine to evaluate a corresponding portion of the conditional statement.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram illustrating a network environment, according to one embodiment of the invention.

FIG. 2 is a logical view illustrating a database abstraction model constructed over an underlying physical database, according to one embodiment of the invention.

FIGS. 3A-3C illustrate a relational view of software components for processing abstract rules in a query engine and a rule engine, according to one embodiment of the invention.

FIG. 4 is a flow diagram illustrating a method for processing abstract rules in a query engine and a rule engine, according to one embodiment of the invention.

### DETAILED DESCRIPTION OF THE PREFERRED EMBODIMENTS

Embodiments of the invention provide techniques for processing abstract rule sets in a query engine. In general, an abstract rule is analyzed to determine which functions may be processed as queries by a query engine. Typically, processing an abstract rule in a query engine can require less processing time and steps than processing in a rule engine, and is thus usually a preferable approach.

In one embodiment, if the abstract rule as a whole can be processed as a query, it is translated into a query rule and processed by a query engine. If only some portion of the abstract query is suitable for processing as a query, the Boolean logic of the rule is evaluated to determine if the abstract rule can be processed in two stages. If so, one portion of the abstract rule is processed by a query engine, and the results are used as an input to process the remaining portion in the rule engine. If the Boolean logic precludes splitting the abstract rule, or if no portion of the abstract rule is suitable to be processed as a query, the entire abstract rule is translated to an executable rule, which is processed by the rule engine.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored, and (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

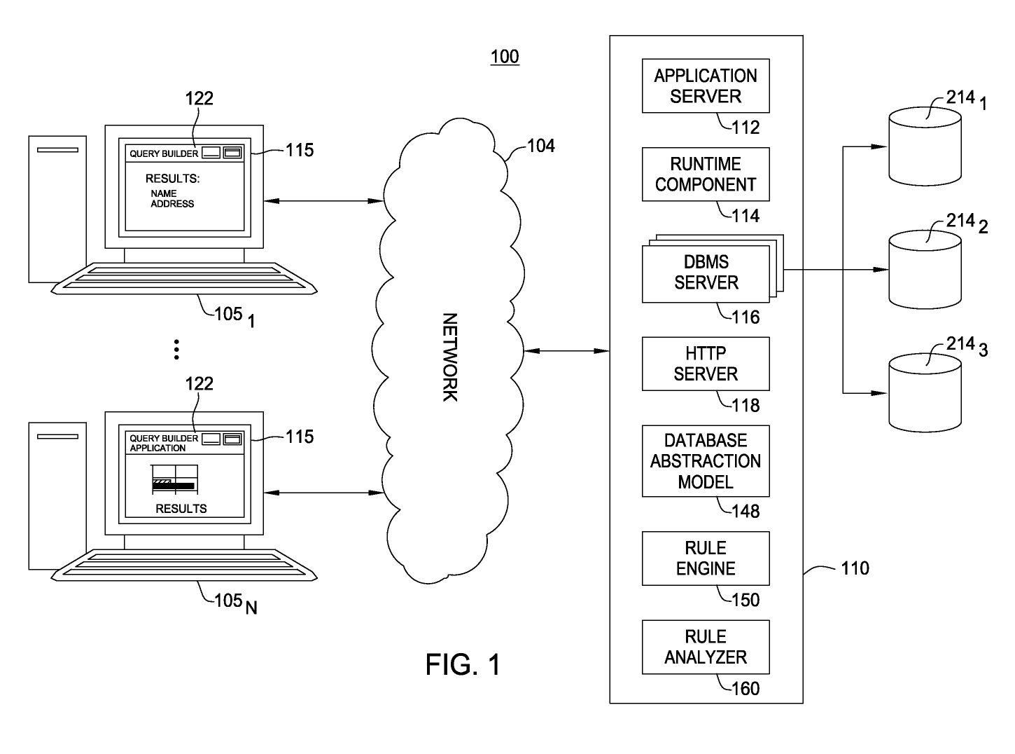

FIG. 1 illustrates a network environment 100 using a client-server configuration. Client computer systems 105_{1-N} include an interface that enables network communications with other systems over network 104. The network 104 may be a local area network where both the client system 105 and server system 110 reside in the same general location, or may be network connections between geographically distributed systems, including network connections over the Internet. Client system 105 generally includes a central processing unit (CPU) connected by a bus to memory and storage (not shown). Each client system 105 is typically running an operating system configured to manage interaction between the computer hardware and the higher-level software applications running on the client system 105 (e.g., a Linux® distribution, a version of the Microsoft Windows® operating system IBM's AIX® or OS/400®, FreeBSD, and the like). (“Linux” is a registered trademark of Linus Torvalds in the United States and other countries.)

The server system 110 may include hardware components similar to those used by the client system 105. Accordingly, the server system 110 generally includes a CPU, a memory, and a storage device, coupled by a bus (not shown). The server system 110 is also running an operating system, (e.g., a Linux® distribution, Microsoft Windows®, IBM's OS/400® or AIX®, FreeBSD, and the like).

The network environment 100 illustrated in FIG. 1, however, is merely an example of one computing environment. Embodiments of the present invention may be implemented using other environments, regardless of whether the computer systems are complex multi-user computing systems, such as a cluster of individual computers connected by a high-speed network, single-user workstations, or network appliances lacking non-volatile storage. Further, the software applications illustrated in FIG. 1 and described herein may be implemented using computer software applications executing on existing computer systems, e.g., desktop computers, server computers, laptop computers, tablet computers, and the like. However, the software applications described herein are not limited to any currently existing computing environment or programming language, and may be adapted to take advantage of new computing systems as they become available.

In one embodiment, users interact with the server system 110 using a graphical user interface (GUI) provided by a user interface 115. In a particular embodiment, GUI content may comprise HTML documents (i.e., web-pages) rendered on a client computer system 105₁ using web-browser 122. In such an embodiment, the server system 110 includes a Hypertext Transfer Protocol (HTTP) server 118 (e.g., a web server such as the open source Apache web-server program or IBM's Web Sphere® program) configured to respond to HTTP requests from the client system 105 and to transmit HTML documents to client system 105. The web-pages themselves may be static documents stored on server system 110 or generated dynamically using application server 112 interacting with web-server 118 to service HTTP requests. Alternatively, client application 120 may comprise a database front-end, or query application program running on client system 105_{N}. The web-browser 122 and application 120 may be configured to allow a user to compose an abstract query, and to submit the query to the runtime component 114 for processing.

As illustrated in FIG. 1, server system 110 may further include a runtime component 114, a database management system (DBMS) 116, a database abstraction model 148, a rule engine 150, and a rule analyzer 160. In one embodiment, these components may be provided using software applications executing on the server system 110. The DBMS 116 includes a software application configured to manage databases 214₁₋₃. That is, the DBMS 116 communicates with the underlying physical database system, and manages the physical database environment behind the database abstraction model 148. Users interact with the user interface 115 to compose an abstract query within the database abstraction model 148, and to submit the abstract query to the runtime component 114 for processing.

In one embodiment, the runtime component 114 may be configured to receive an abstract query, and in response, to generate a “resolved” or “concrete” query that corresponds to the schema of underlying physical databases 214. For example, the runtime component 114 may be configured to generate one or more Structured Query Language (SQL) queries from an abstract query. The resolved queries generated by the runtime component 114 are supplied to DBMS 116 for execution. Additionally, the runtime component 114 may be configured to modify the resolved query with additional restrictions or conditions, based on the focus of the abstract query.

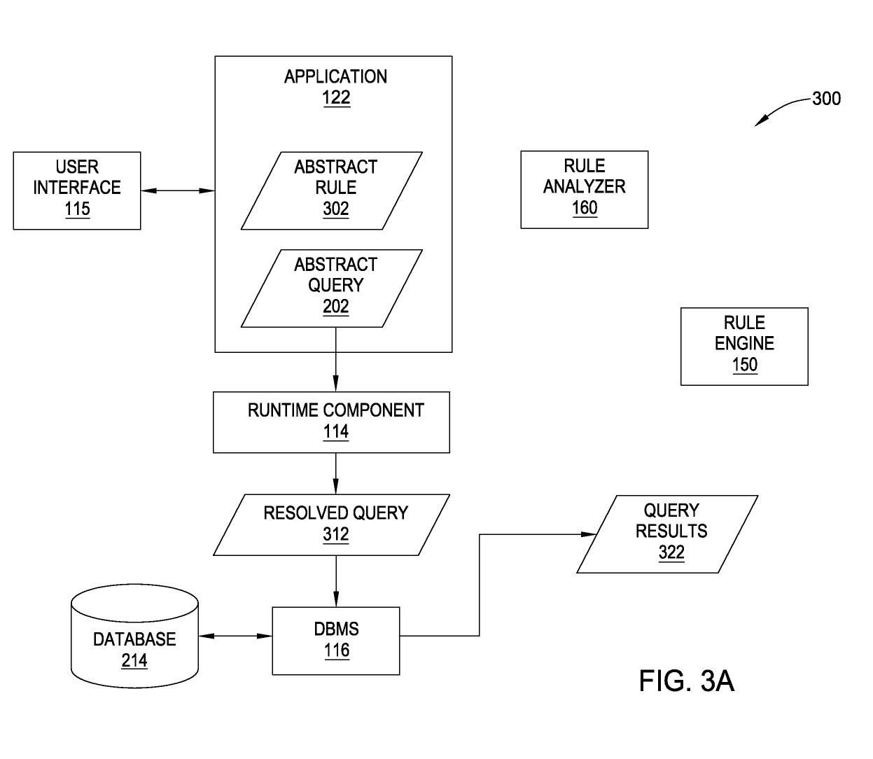

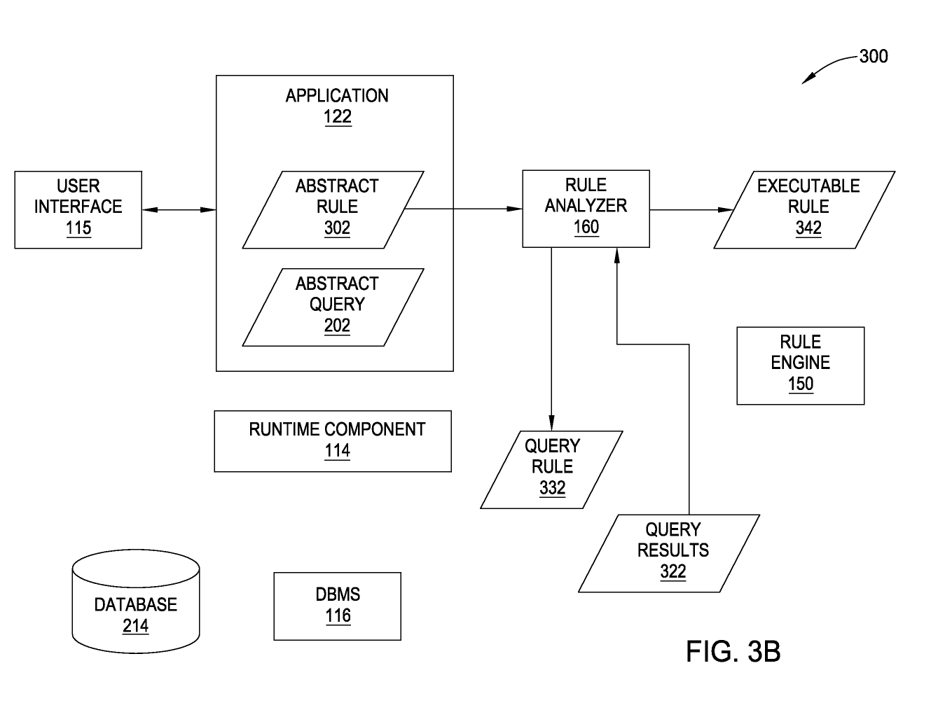

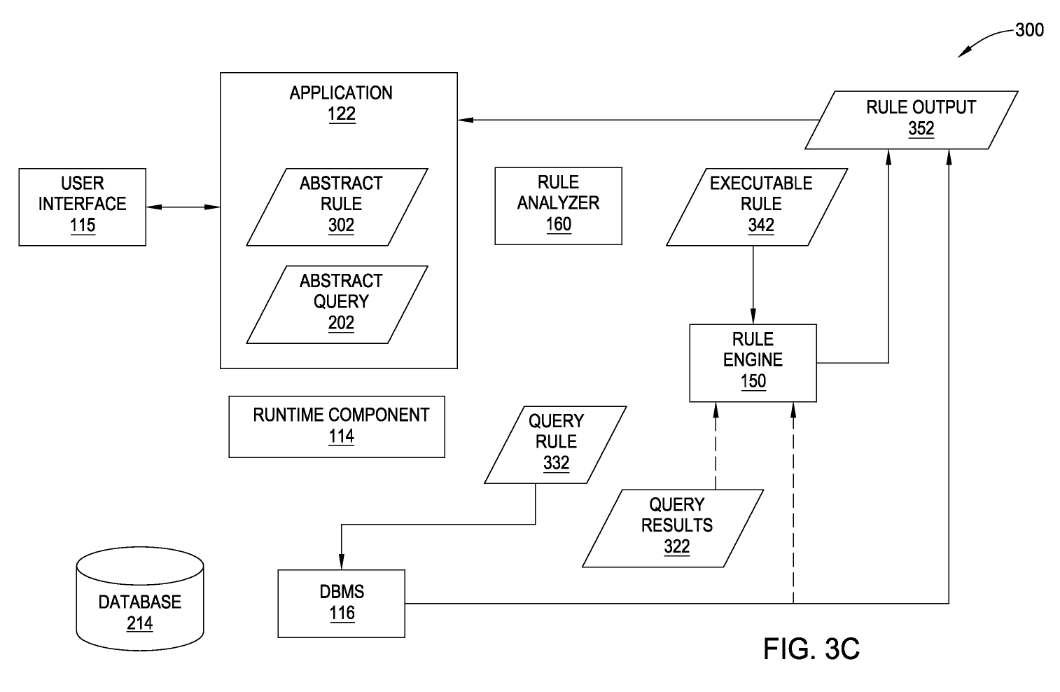

In one embodiment, users may interact with the user interface 115 to compose an abstract rule within the database abstraction model 148. The abstract rule may then be analyzed by the rule analyzer 160, which determines whether the abstract rule will be processed by the rule engine 150, by the DBMS 116, or a combination of both. More specifically, the rule analyzer 160 is configured to determine how to process the abstract rule based on the functions included in each abstract rule, as well as the Boolean logic required to properly process those functions. Some examples of functions included in an abstract rule are mathematical functions (e.g., addition, multiplication, division), statistical functions (e.g., mean, average), and fuzzy logic functions. Further, the rule analyzer 160 may be configured to translate the abstract rule into the formats required by the rule engine 150 and the DBMS 116. The functions of the rule analyzer 160 are discussed in more detail below with reference to FIGS. 3A-3C.

The rule engine 150 represents one or more rule engines (i.e., inference engines) configured to carry out analysis routines for various purposes, including know-how management, decision making and statistical analysis. More specifically, the rule engine 150 can carry out analysis routines by processing rule sets including one or more rules, with each rule having predicates and actions. The rule engine 150 may be a software application installed on server 110. Alternatively, the rule engine 150 may be provided as “software as a service” (SAAS), wherein functions on a remote hosted system are accessed over a network as required.

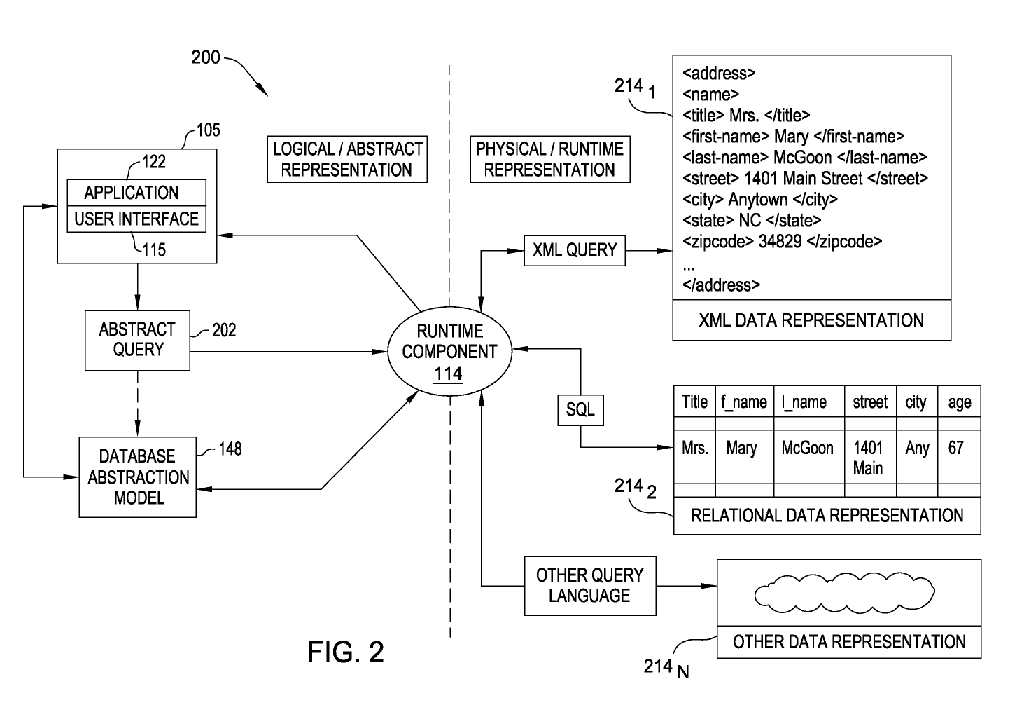

FIG. 2 illustrates a plurality of interrelated components of a database abstraction model, along with relationships between the logical view of data provided by the abstraction model environment (the left side of FIG. 2), and the underlying physical database mechanisms used to store the data (the right side of FIG. 2).

In one embodiment, users compose an abstract query 202 using the user interface 115. An abstract query 202 is generally referred to as “abstract” because it is composed using logical fields rather than direct references to data structures in the underlying physical databases 214. The logical fields include specifications of access methods for mapping to a physical view of the data, including various underlying storage mechanisms. For example, for a given logical field, the runtime component may be generate an XML query that queries data from database 214₁, an SQL query of relational database 214₂, or other query composed according to another physical storage mechanism using “other” data representation 214₃, or combinations thereof (whether currently known or later developed). Particular types of access methods and embodiments for executing abstract queries are further described in commonly assigned U.S. Pat. No 6,996,558, entitled “Application Portability and Extensibility through Database Schema and Query Abstraction,” and commonly assigned, co-pending application titled “Abstract Query Plan,” Ser. No. 11/005,418, filed Dec. 6, 2004, both of which are incorporated herein in their entirety.

FIGS. 3A-3C illustrate a relational view 300 of software components for processing abstract rules, according to one embodiment of the invention. FIG. 3A illustrates a first (i.e., initial) stage in processing an abstract rule. The software components of relational view 300 include user interface 115, application 122, runtime component 114, database management system (DBMS) 116, database 214, rule engine 150, and rule analyzer 160.

As shown, the application 122 includes two data objects, an abstract rule 302 and an abstract query 202. Illustratively, the abstract rule 342 and abstract query 202 may be created in the user interface 115, which in this example is a graphical user interface. However, it should be noted that the user interface 115 is only shown by way of example; any suitable requesting entity may create abstract rules 302 and abstract queries 202 (e.g., the application 122, an operating system, or an end user). Accordingly, all such implementations are broadly contemplated. As described above, the abstract query 202 is composed by using logical fields to specify query conditions and results fields. Similarly, the abstract rule 302 is composed by using logical fields to specify a rule predicate and a rule action. Such logical fields may be specified, for example in a database abstraction model 148.

In one embodiment, the abstract query 202 is translated by the runtime component 114 into a resolved query 312. The resolved query 302 is submitted to the DBMS 116 for execution against the database 214, thus producing a set of query results 312. The query results 312 include field values which can be used as inputs to an abstract rule 302. In many situations, such field values include a primary entity for which the abstract rule 302 is being executed. For example, in the case of an abstract rule set configured to provide treatment recommendations for doctors in medical institutions, a primary entity may be defined as a patient or test subject. In such situations, the rule predicate (i.e., condition) may be evaluated with field values related to a specific primary entity, and the rule action may apply only to the specific primary entity. However, it should be noted that the present invention is not limited to the use of field values obtained from query results as inputs to the abstract rule 302. Instead, any suitable inputs to the abstract rule 302 are broadly contemplated including, for instance, a user inputting data via the user interface 115.

FIG. 3B illustrates a second stage in processing an abstract rule, according to one embodiment of the invention. As shown, the abstract rule 302 is analyzed by the rule analyzer 160. In one embodiment, the rule analyzer 160 is configured to translate the abstract rule 302 into a query rule 332 and/or an executable rule 342. As used herein, a query rule is a database query that includes predicates that correspond to the predicates of an abstract rule. Query rules are processed in query engines (e.g., DBMS 116), and are thus different from executable rules, which are processed in rule engines (e.g., rule engine 150). In many cases, query rules may be preferred to executable rules. One reason for this preference is that processing a query rule is usually more efficient than processing an executable rule. Another reason is that using query rules requires fewer processing steps than using executable rules, for example the step of translating the abstract rule to the proper rule engine format.

The translation of abstract rules into query rules may be illustrated with the following simple abstract rule:

IF (gender = male) AND (blood sugar > 36)
THEN diagnosis = diabetes

In this example, the abstract rule has two predicates, one related to gender, and one related to blood sugar. Typically, an abstract rule may be evaluated for a specific primary entity (e.g., a patient named “J. Doe”). Thus, it should be assumed that the above abstract rule is evaluated by retrieving the gender and blood sugar values of a given patient, and then comparing the values to the predicate conditions. The functions required to evaluate these predicates are a simple comparison (e.g., “gender=male”), and a numerical comparison (e.g., “blood sugar>36”). As is known to one of skill in the art, equivalent comparison functions can be performed in most query languages (e.g., SQL). Thus, according to one embodiment of the invention, this abstract rule can be translated into a query rule, meaning a query that incorporates the rule predicates in the form of query predicates. For example, the above abstract rule may be translated as the following query rule, composed in the SQL language:

SELECT patient, gender, blood sugar
WHERE (patient = “J. Doe”) AND (gender = male) AND
(blood sugar > 36)

In these examples, the query rule explicitly includes the primary entity (i.e., patient), while the abstract rule does not. This illustrates the aspect that, when query results including multiple entities are used as input, the abstract rule may be translated into multiple query rules, each including a separate primary entity. Accordingly, in the embodiment illustrated in FIG. 3B, the rule analyzer 160 may be configured to generate multiple query rules 332 based on the abstract rule 302 and the multiple primary entities included in the query results 322.

In one embodiment, the rule analyzer 160 may be configured to analyze the functions and Boolean logic included in the predicates (i.e., conditions) of the abstract rule 302 and, on that basis, to determine how to translate the abstract rule 302. Some examples of the types of functions included in rule predicates are statistical, aggregation, and fuzzy logic functions. If all functions included in the abstract rule 302 are available in the DBMS 116 (i.e., query engine), the entire abstract rule 302 can be translated to the query rule 332. If none of the functions included in the abstract rule are available in the query engine, the entire abstract rule 302 can be translated to the executable rule 342.

If only a sub-set of the functions included in the abstract rule 302 are available in the query engine, the rule analyzer 160 analyzes the Boolean logic of the rule predicates to determine whether they can be split into two (or more) groupings, or sub-rules. Each sub-rule may then be translated into either a query rule 332 or an executable rule 342, depending on the included functions and Boolean logic. The query rule(s) 332 may then be processed by the DBMS 116, with the results used as an input for processing the executable rule(s) 342 in the rule engine 150. Once all rules have been processed, the end result is the same as if the entire abstract rule had been processed in a single step. This aspect is explained further below with reference to FIG. 3C.

If only a sub-set of the functions included in the abstract rule 302 are available in the query engine, and if the Boolean logic precludes splitting the abstract rule 302 into sub-rules, the entire abstract rule 302 is translated to the executable rule 342. This situation occurs when the functions included in the rule predicates are linked in such a way that they cannot be evaluated separately. Most commonly, the abstract rule cannot be split if it includes the logical OR operator such that it links query functions and rule engine functions.

FIG. 3C illustrates a third (and final) stage in processing an abstract rule, according to one embodiment of the invention. More specifically, FIG. 3C illustrates three options for processing the translated rule. As shown, in the situation where the entire abstract rule 302 has translated to the query rule 332 (as illustrated in FIG. 3B), the rule is processed by the DBMS 116, resulting in the rule output 352. As also shown, in the situation where the entire abstract rule 302 has translated to the executable rule 342, the rule is processed by the rule engine 150, resulting in the rule output 352.

FIG. 3C also illustrates the situation where the abstract rule 302 has been split into the query rule 332 and the executable rule 342. In this situation, the query rule 332 is initially processed by the DBMS 116, with the results sent to the rule engine 150. The rule engine 150 processes the executable rule 342, utilizing the output of the DBMS 116 and the query results 322 (both shown as dotted lines) as rule inputs. The rule engine 150 then produces the rule output 352. It is contemplated that, in some situations, it may be advantageous to process the executable rule 342 first, and use the results as an input for processing the query rule 332.

The rule output 352, whether generated by the rule engine 150 or the DBMS 116, may be passed to the application 122, and may be used to implement an analysis routine. That is, the rule output 352 may be used to fire or execute actions defined in the rules, or to convey messages or recommendations to users. For example, for a set of abstract rules configured to provide treatment recommendations for doctors in medical institutions, the rule output 352 may include possible diagnoses and evaluations of patient conditions that may be presented to doctors who are using application 122.

It should be noted that the components of the relational view 300 are illustratively shown as separate software components. However, embodiments are contemplated in which functionality of any component may be incorporated in other component(s).

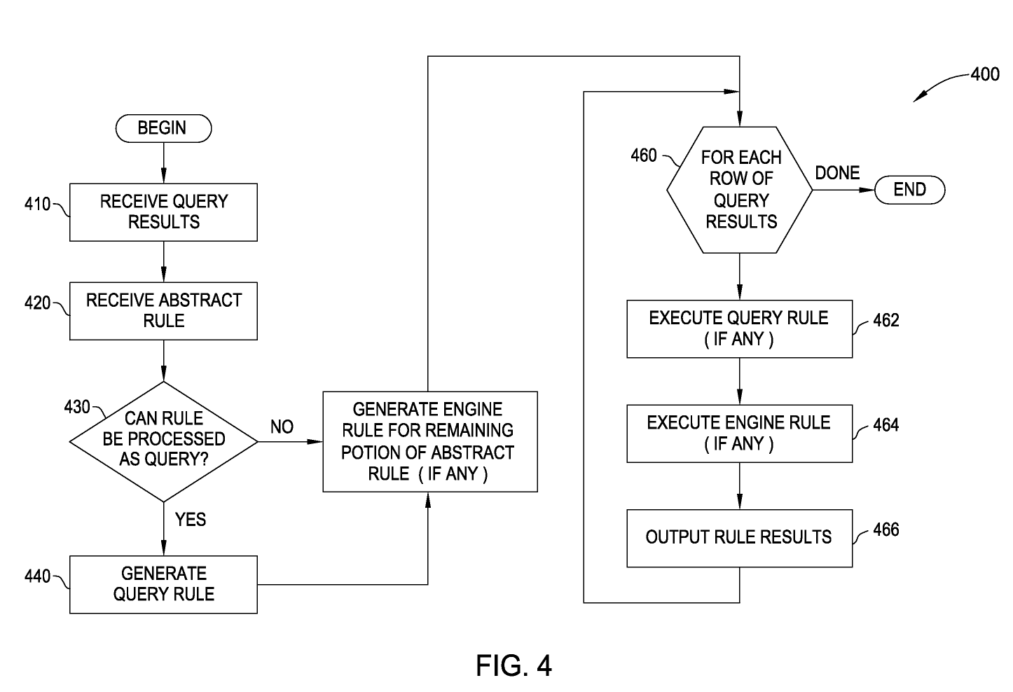

FIG. 4 is a flow diagram illustrating a method 400 for processing abstract rules in a query engine, according to one embodiment of the invention. The method 400 begins at step 410, by receiving a set of query results. In one embodiment, the query results may be the output of an abstract query. For example, the query results 322 are generated when the abstract query 202 is translated by the runtime component 114 to the resolved query 312, which is then processed in the DBMS 116. At step 420, an abstract rule is received. The abstract rule may be generated, for example, by a user interacting with the user interface 115, or by some other entity.

At step 430, a determination is made of whether the abstract rule can be processed as a query rule. In one embodiment, this determination may be based on the functions and Boolean logic required to process the abstract rule. More specifically, step 430 may determine if all functions included in the abstract rule are available in a query engine (e.g., DBMS 116). If so, the entire abstract rule may translated into the query rule at step 440. However, if only some subset of the functions included in the abstract rule is available in the query engine, and if the Boolean logic required by the abstract rule allows it, the abstract rule may be split into two portions. The first portion may include the functions that are available in the query engine, and is translated to a query rule at step 440. At step 450, any remaining portion of the abstract rule may be translated into an executable rule. Thus, if no portion of the abstract rule can be processed as a query rule, step 440 does not occur, and the entire abstract rule is translated to an executable rule at step 450. Translating to an executable rule means that the abstract rule is resolved to the physical database (e.g., database 214). That is, instead of the logical fields referenced by the abstract rule, the executable rule references data structures in the underlying physical database. Translating to an executable rule may also include converting the rule to the data format required by the selected rule engine (e.g., rule engine 150). One example of such a data format is the Arden syntax, which is used in rule engines for medical knowledge. Steps 430, 440, and 450 may be performed, for example, by the rule analyzer 160.

At step 460, the method 400 enters a loop (defined by steps 460, 462, 464, and 466) for processing each row of the query results received in step 410. Each row of the query results may represent a primary entity, for example a patient at a medical facility. At step 462, if a query rule was generated at step 440, it is executed by a query engine. For example, the query rule 302 may be executed by the DBMS 116. In other words, the portion of the abstract query that was translated to a query rule is processed, with the data related to a given entity used as a rule input. At step 464, if an executable rule was generated at step 440, it is executed by a rule engine. For example, the executable rule 355 may be executed by the rule engine 150. If the abstract query was split into two portions, the output of the query rule at step 462 may be used as a rule input at step 464. At step 466, the results of the processed rule are output. The output may be used, for example, to generate a medical recommendation, to be displayed to a user, or for some other purpose. Once all rows of the query results are completed at step 460, the method 400 ends.

While the foregoing is directed to embodiments of the present invention, other and further embodiments of the invention may be devised without departing from the basic scope thereof, and the scope thereof is determined by the claims that follow.

What is claimed is:

1. A computer-implemented method for processing an abstract rule, comprising:
receiving an abstract rule having a conditional statement and a consequential statement; wherein the consequential statement defines a particular recommendation that is returned when the conditional statement is satisfied; wherein the conditional statement and the consequential statement are defined using logical field definitions defined in an abstraction model that models underlying physical data in a manner making a schema of the physical data transparent to a user of the abstraction model;
determining one or more functions required to evaluate the conditional statement;
determining at least one function, from the one or more required functions, that can be processed by a query engine;
generating a query statement comprising the determined at least one function, such that the resulting query statement evaluates a portion of the conditional statement; wherein the resulting query statement is formatted for processing by the query engine;
determining at least one remaining function of the one or more required functions, wherein the at least one remaining function is not included in the query statement; and
transforming the at least one remaining function into an executable rule, wherein the executable rule is formatted for processing by a rule engine according to the determined logical sequence.

2. The computer-implemented method of claim 1, further comprising:
processing the query statement by the query engine; and
if the conditional statement is resolved to true for the processed query statement, returning the particular recommendation.

3. The computer-implemented method of claim 2, wherein processing the query statement comprises:
selecting one or more field values from a query result set.

4. The computer-implemented method of claim 2, further comprising:
processing the executable rule by the rule engine, using the output of the processed query statement as an input to the rule engine, wherein the output of processing the executable rule is the same as the output resulting from processing the entire abstract rule as an executable rule by a rule engine; and
if the conditional statement is resolved to true for the processed query statement, returning the particular recommendation.

5. The computer-implemented method of claim 1, wherein generating a query statement comprising the determined at least one function comprises:
determining a logical sequence required for processing the one or more required functions, and
generating the query statement in accordance to the determined logical sequence.

6. The computer-implemented method of claim 1, wherein transforming the at least one remaining function into an executable rule comprises:
retrieving a specification of the at least one remaining function in a first computer-readable language; and
transforming the specification into a language which is accepted by the rule engine.

7. The computer-implemented method of claim 1, wherein generating a query statement comprises:
receiving one or more entity identifiers from a query result set; and
including, in each query statement, one of the one or more entity identifiers.

8. A computer readable storage medium containing a program which, when executed, performs an operation, comprising:
receiving an abstract rule having a conditional statement and a consequential statement; wherein the consequential statement defines a particular recommendation that is returned when the conditional statement is satisfied; wherein the conditional statement and the consequential statement are defined using logical field definitions defined in an abstraction model that models underlying physical data in a manner making a schema of the physical data transparent to a user of the abstraction model;
determining one or more functions required to evaluate the conditional statement;
determining at least one function, from the one or more required functions, that can be processed by a query engine;
generating a query statement comprising the determined at least one function, such that the resulting query statement evaluates a portion of the conditional statement; wherein the resulting query statement is formatted for processing by the query engine;
determining at least one remaining function of the one or more required functions, wherein the at least one remaining function is not included in the query statement; and
transforming the at least one remaining function into an executable rule, wherein the executable rule is formatted for processing by a rule engine according to the determined logical sequence.

9. The computer readable storage medium of claim 8, further comprising:
processing the query statement by the query engine; and
if the conditional statement is resolved to true for the processed query statement, returning the particular recommendation.

10. The computer readable medium of claim 9, wherein processing the query statement comprises:
selecting one or more field values from a query result set.

11. The computer readable storage medium of claim 9, further comprising:
processing the executable rule by the rule engine, using the output of the processed query statement as an input to the rule engine, wherein the output of processing the executable rule is the same as the output resulting from processing the entire abstract rule as an executable rule by a rule engine; and
if the conditional statement is resolved to true for the processed query statement, returning the particular recommendation.

12. The computer readable storage medium of claim 8, wherein generating a query statement comprising the determined at least one function comprises:
determining a logical sequence required for processing the one or more required functions, and
generating the query statement in accordance to the determined logical sequence.

13. The computer readable storage medium of claim 8, wherein transforming the at least one remaining function into an executable rule comprises:
retrieving a specification of the at least one remaining function in a first computer-readable language; and
transforming the specification into a language which is accepted by the rule engine.

14. The computer readable storage medium of claim 8, wherein generating a query statement comprises:
receiving one or more entity identifiers from a query result set; and
including, in each query statement, one of the one or more entity identifiers.

15. A system, comprising:
a processor; and
a memory containing a program configured to process an abstract rule by performing an operation, comprising:
receiving an abstract rule having a conditional statement and a consequential statement; wherein the consequential statement defines a particular recommendation that is returned when the conditional statement is satisfied; wherein the conditional statement and the consequential statement are defined using logical field definitions defined in an abstraction model that models underlying physical data in a manner making a schema of the physical data transparent to a user of the abstraction model;
generating a query statement comprising at least one function required to evaluate a portion of the conditional statement, wherein the query statement is formatted for processing by the query engine.

16. The system of claim 15, wherein the at least one function is selected by:
determining one or more functions required to evaluate the conditional statement;
determining a logical sequence required for processing the one or more required functions; and
selecting, of one or more required functions, at least one function that can be processed by a query engine according to the determined logical sequence.

17. The system of claim 15, wherein the operation further comprises:
processing the query statement by the query engine; and
if the conditional statement is resolved to true for the processed query statement, returning the particular recommendation.

18. The system of claim 15, wherein the operation further comprises:
determining at least one remaining function of the one or more required functions, wherein the at least one remaining function is not included in the query statement; and
transforming the at least one remaining function into an executable rule, wherein the executable rule is formatted for processing by a rule engine.

19. The system of claim 18, wherein the operation further comprises:
processing the query statement by the query engine;
processing the executable rule by the rule engine, using the output of the processed query statement as an input to the rule engine, wherein the output of processing the executable rule is the same as the output resulting from processing the entire abstract rule as an executable rule by a rule engine; and
if the conditional statement is resolved to true for the processed query statement, returning the particular recommendation.

20. A computer-implemented method for processing an abstract rule, comprising:
receiving an abstract rule having a conditional statement and a consequential statement; wherein the consequential statement defines a particular recommendation that is returned when the conditional statement is satisfied; wherein the conditional statement and the consequential statement are defined using logical field definitions defined in an abstraction model that models underlying physical data in a manner making a schema of the physical data transparent to a user of the abstraction model;
generating a query statement comprising at least one function required to evaluate a portion of the conditional statement, wherein the query statement is formatted for processing by the query engine.

21. The computer-implemented method of claim 20, wherein the at least one function is selected by:
determining one or more functions required to evaluate the conditional statement;
determining a logical sequence required for processing the one or more required functions; and
selecting, of one or more required functions, at least one function that can be processed by a query engine according to the determined logical sequence.

22. The computer-implemented method of claim 20, further comprising:
processing the query statement by the query engine; and
if the conditional statement is resolved to true for the processed query statement, returning the particular recommendation.

23. The computer-implemented method of claim 20, further comprising:
determining at least one remaining function of the one or more required functions, wherein the at least one remaining function is not included in the query statement; and
transforming the at least one remaining function into an executable rule, wherein the executable rule is formatted for processing by a rule engine.

24. The computer-implemented method of claim 23, further comprising:
processing the query statement by the query engine;
processing the executable rule by the rule engine, using the output of the processed query statement as an input to the rule engine, wherein the output of processing the executable rule is the same as the output resulting from processing the entire abstract rule as an executable rule by a rule engine; and
if the conditional statement is resolved to true for the processed query statement, returning the particular recommendation.

25. The computer-implemented method of claim 23, wherein transforming the at least one remaining function into an executable rule comprises:
retrieving a specification of the at least one remaining function in a first computer-readable language; and
transforming the specification into a language which is accepted by the rule engine.
